(19) United States
(12) Patent Application Publication
(10) Pub. No.: US 2024/0421490 A1
(43) Pub. Date: Dec. 19, 2024

(54) TERMINAL ANTENNA AND ELECTRONIC DEVICE

(71) Applicant: Honor Device Co., Ltd., Shenzhen (CN)

(72) Inventors: Aofang Zhang, Shenzhen (CN); Kunpeng Wei, Shenzhen (CN); Shaojie Chu, Shenzhen (CN); Yiwu Hu, Shenzhen (CN); Yang Lu, Shenzhen (CN)

(21) Appl. No.: 18/703,869

(22) PCT Filed: Apr. 26, 2023
(86) PCT No.: PCT/CN2023/091005

§ 371 Date: Apr. 23, 2024

(30) Foreign Application Priority Data
Jun. 20, 2022 (CN) 202210700287.3

(51) Int. Cl. H01Q 9/04

(52) U.S. Cl. CPC H01Q 9/0442

(57) ABSTRACT

A terminal antenna includes a first radiator. The first radiator includes N radiating elements connected end to end, where N is an integer greater than or equal to 2. One end of any one of the radiating elements is grounded through a reactance element. The N radiating elements include a first radiating element, and a feed is arranged at one end of the first radiating element away from the reactance element.

### CROSS-REFERENCE TO RELATED APPLICATIONS

This application is a national stage of International Application No. PCT/CN2023/091005, filed on Apr. 26, 2023, which claims priority to Chinese Patent Application No. 202210700287.3, filed on Jun. 20, 2022, both which are incorporated herein by reference in their entireties.

### TECHNICAL FIELD

This application relates to the technical field of antennas, and in particular, to a terminal antenna and an electronic device.

### BACKGROUND

An antenna in an electronic device may provide a wireless communication function by radiating electromagnetic waves. When a large amount of the electromagnetic waves are absorbed by a user, health of the user may be affected.

Therefore, the antenna in the electronic device needs to reduce absorption of the electromagnetic waves by a human body while improving radiation performance.

### SUMMARY

Embodiments of this application provide a terminal antenna and an electronic device, which can provide better radiation performance while providing a smaller SAR. Because the SAR is low, absorption of electromagnetic waves by a human body is also low.

To achieve the foregoing objective, the following technical solutions are used in embodiments of this application:

According to a first aspect, a terminal antenna is provided. The terminal antenna is arranged in an electronic device. The terminal antenna includes: a first radiator. The first radiator includes N radiating elements connected end to end, where N is an integer greater than or equal to 2. One end of any one of the radiating elements is grounded through a reactance element. The N radiating elements include a first radiating element, and a feed is arranged at one end of the first radiating element away from the reactance element.

In this way, the terminal antenna provided in embodiments of this application may be obtained by arranging a plurality of radiating elements in series. A larger quantity of radiating elements indicates better radiation performance. By arranging a ground component on each radiating element, a current on a radiator can be uniformly adjusted when the radiating element operates, to obtain relatively uniform current distribution at a feed end and a ground end and stimulate a uniform normal electric field for radiation. In this way, better radiation performance and a lower SAR are obtained.

In a possible design, that the reactance element is arranged at one end of any one of the radiating elements, includes that: for any radiating element, the reactance element is arranged at one end of the radiating element away from the feed. In this way, by arranging the ground component at the end far away from the feed, a radiation situation between the ground component and the feed can be adjusted.

In a possible design, the N radiating elements further include a second radiating element. The second radiating element is arranged on one side of the first radiating element close to the feed, and the reactance element is arranged at a first end of the second radiating element. The second radiating element is connected to a third end of the first radiating element at a second end. The second end is different from the first end, and the third end is an end of the first radiating element at which the feed is arranged. In this way, after radiators of the second radiating element and the first radiating element are connected end to end, the feed may be located at a middle position between the first radiating element and the second radiating element, and may be grounded through the ground component at both ends of the first radiating element and the second radiating element.

In a possible design, the N radiating elements further include a third radiating element. The third radiating element is arranged on one side of the first radiating element away from the feed. The reactance element is arranged at a fourth end of the third radiating element. The third radiating element is connected to a sixth end of the first radiating element at a fifth end. The fifth end is different from the fourth end. The sixth end is an end of the first radiating element away from the feed. In this way, after the third radiating element and the first radiating element are connected end to end, the feed may be arranged at one end of a radiator formed by the third radiating element and the second radiating element, the other end may be grounded through the ground component, and a ground component may also be arranged on the radiator.

In a possible design, a length of any radiating element does not exceed ¼ wavelength of an operating frequency band of the terminal antenna. In this way, the radiating element can cover the operating frequency band by exciting a zero-order mode. Because the length is less than or equal to ¼ of the wavelength, the antenna is more conducive to a miniaturization design.

In a possible design, among the N radiating elements, a farther distance away from the feed indicates a smaller width of the radiating element. In this way, by adjusting the width of the radiating element, a current density of the radiating element away from the feed is increased, to be closer to a current density of the radiating element close to the feed. As a result, normal electric field intensity generated by the antenna as a whole tends to be uniform.

In a possible design, the reactance element includes any one of the following: a lumped inductor, a distributed inductor, and an electrical connection component. In this way, in different embodiments, the ground component may have different implementations, such as a lumped inductor, a distributed inductor (such as a serpentine line), or a function of an inductor of a ground setup through an equivalent inductance of an electrical connection device (such as a shrapnel and a thimble).

In a possible design, a tuning capacitor is also arranged between the reactance element and a reference ground. In this way, by adjusting a size of the tuning capacitor before grounding, frequency selection and frequency tuning may be implemented.

In a possible design, the operating frequency band of the terminal antenna includes 5150 MHz to 5850 MHZ, and the inductor of the reactance element is in a range of [0.5 nH, 5 nH]. In this way, by adjusting the inductor of the ground component to this range, the zero-order mode can cover the operating frequency band of 5G WiFi.

In a possible design, when the terminal antenna operates, a uniform normal electric field is distributed near the radiator of the terminal antenna. In this way, better radiation performance is provided through uniform electric field radiation. Because the electric field is uniformly distributed, there are no areas where energy is particularly concentrated, so that the SAR is lower. In addition, because the human body absorbs less normal electric field, the SAR is further reduced.

According to a second aspect, an electronic device is provided. The terminal antenna according to any one of the first aspect and any possible design of the first aspect is arranged in the electronic device. When transmitting or receiving a signal, the electronic device transmits or receives the signal through the terminal antenna.

It should be understood that the technical features of the technical solution provided in the second aspect above can all correspond to the terminal antenna provided in the first aspect and any possible design of the first aspect, and therefore, similar beneficial effects can be achieved. Details are not described herein again.

### BRIEF DESCRIPTION OF THE DRAWINGS

FIG. 1 is a schematic diagram of interaction of a plurality of electronic devices;

FIG. 2 is a schematic composition diagram of an antenna;

FIG. 3 is a schematic diagram of radiation of a tablet computer;

FIG. 4 is a schematic diagram of electric field distribution of a loop antenna;

FIG. 5 is a schematic composition diagram of an electronic device according to an embodiment of this application;

FIG. 6 is a schematic diagram of antenna arrangement according to an embodiment of this application;

FIG. 7 is a schematic composition diagram of an antenna according to an embodiment of this application;

FIG. 8 is a schematic composition diagram of a radiating element according to an embodiment of this application;

FIG. 9 is a schematic composition diagram of a terminal antenna according to an embodiment of this application;

FIG. 10 is a schematic diagram of electric field simulation according to an embodiment of this application;

FIG. 11 is a schematic diagram of hotspot distribution according to an embodiment of this application;

FIG. 12 is a schematic diagram of efficiency simulation comparison according to an embodiment of this application;

FIG. 13 is a schematic composition diagram of a terminal antenna according to an embodiment of this application;

FIG. 14 is a schematic diagram of electric field simulation according to an embodiment of this application;

FIG. 15 is a schematic composition diagram of a terminal antenna according to an embodiment of this application;

FIG. 16 is a schematic composition diagram of a terminal antenna according to an embodiment of this application;

FIG. 17 is a schematic composition diagram of a terminal antenna according to an embodiment of this application;

FIG. 18 is a schematic diagram of electric field simulation according to an embodiment of this application;

FIG. 19 is a schematic diagram of hotspot distribution according to an embodiment of this application;

FIG. 20 is a schematic composition diagram of a terminal antenna according to an embodiment of this application;

FIG. 21 is a schematic diagram of hotspot distribution according to an embodiment of this application;

FIG. 22 is a schematic composition diagram of a terminal antenna according to an embodiment of this application;

FIG. 23 is a schematic diagram of a simulation model according to an embodiment of this application;

FIG. 24 is a schematic composition diagram of a terminal antenna according to an embodiment of this application; and

FIG. 25 is a schematic composition diagram of a terminal antenna according to an embodiment of this application.

### DETAILED DESCRIPTION OF ILLUSTRATIVE EMBODIMENTS

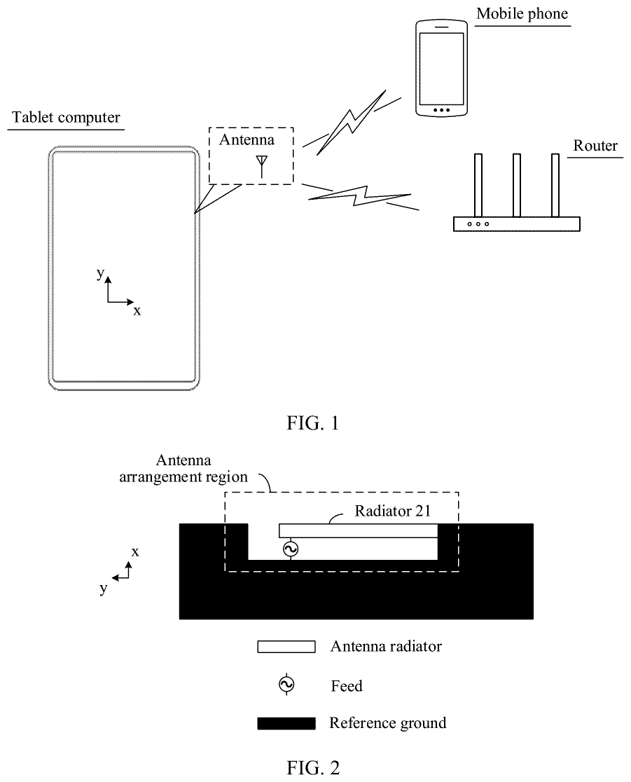

An electronic device implements wireless communication with another device through an antenna arranged therein. For example, referring to FIG. 1, an example in which a tablet computer communicates with another device is used. An antenna may be arranged on a lateral side (such as a long side) of the tablet computer. Through a conversion capability between analog signals of the antenna and wireless electromagnetic waves, wireless signals can be transmitted and received, to establish a wireless communication connection with electronic devices such as a mobile phone and a router.

For example, FIG. 2 is a schematic diagram of a design of a conventional antenna. In this example, an antenna arrangement region may be arranged on the lateral side of the tablet computer. An antenna may be arranged in this antenna arrangement region. In the example shown in FIG. 2, a loop (Loop) antenna may be arranged in the antenna arrangement region to support a wireless communication function of the tablet computer.

The loop antenna may include a radiator 21, and a feed and a ground point may be respectively arranged at both ends of the radiator 21.

The feed may be configured to couple to a radio frequency module, to receive a radio frequency signal (an analog signal) from the radio frequency module and feed the radio frequency signal to the antenna in a transmitting scenario, and transmit the radio frequency signal in a form of electromagnetic waves through the antenna, or transmit the analog signal that is obtained by converting the electromagnetic waves and that is received by the antenna to the radio frequency in a receiving scenario, so that the radio frequency module can process the analog signal to implement signal reception.

The ground point may be a connection point between the radiator and a reference ground. For example, the radiator 21 may be directly connected to the reference ground at this ground point. In another example, the radiator 21 may be connected to the reference ground at this ground point through electronic components such as a capacitor, an inductor, and a resistor.

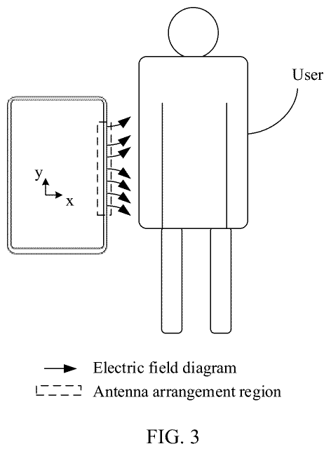

Refer to FIG. 3. It should be understood that, the radio frequency signal may radiate in the form of the electromagnetic waves when the antenna operates. Correspondingly, when a user uses the electronic device and is close to the antenna, the user is affected by the electromagnetic waves emitted by the antenna. In this application, a specific absorption rate (Specific Absorption Rate, SAR) of the electromagnetic waves may be used to describe absorption of the electromagnetic wave by a human body when the antenna operates, that is, an impact of the electromagnetic waves emitted by the antenna on the human body. Because radiation performance of the antenna at different operating frequencies is different, the SAR at different frequency points may also be different. A higher SAR indicates greater absorption of the electromagnetic waves by the human body at this frequency point, and a greater impact of the electromagnetic waves emitted by the antenna on the human body when the antenna operates. On the contrary, a lower SAR indicates smaller absorption of the electromagnetic waves by the human body at this frequency point, and a smaller impact of the electromagnetic waves emitted by the antenna on the human body when the antenna operates.

Therefore, to control the impact on the user's human body when the antenna operates, it is necessary to control the SAR of the antenna within an operating frequency band. Operators in most regions also use the SAR of the antenna as an indicator for a terminal equipment access.

The following provides description of SAR characteristics when the antenna operates from a perspective of radiation performance and a perspective of electrical parameter distribution.

From the perspective of radiation performance, when the antenna operates, the radiation performance may be identified by efficiency (such as radiation efficiency or system efficiency), and the like. When other conditions are the same, better radiation performance indicates higher efficiency, greater intensity of the electromagnetic waves radiated by the antenna into space, and a higher SAR. Correspondingly, worse radiation performance indicates lower efficiency, smaller intensity of the electromagnetic waves radiated by the antenna into space, and a lower SAR.

From the perspective of electrical parameter distribution, when the antenna operates, an example in which an electric field distributed on the radiator is the electrical parameter is used. When other conditions are the same, when the antenna operates, a more dispersed electric field indicates a lower SAR. Correspondingly, a more concentrated electric field indicates a higher SAR. For a corresponding relationship between distribution of other electrical parameters and the SAR, such as a corresponding relationship between current distribution and the SAR, and a corresponding relationship between magnetic field distribution and the SAR, reference may be made to the corresponding relationship between the foregoing electric field distribution and the SAR. Details are not described herein again.

It can be seen that an effect of adjusting the SAR may be implemented by adjusting the radiation performance and the electrical parameter distribution of the antenna.

In general, to ensure quality of wireless communication provided by the antenna, it is clearly not a good choice to meet a requirement of the low SAR by reducing the radiation performance. For an antenna with a known structure, electrical parameter distribution is relatively fixed and difficult to adjust.

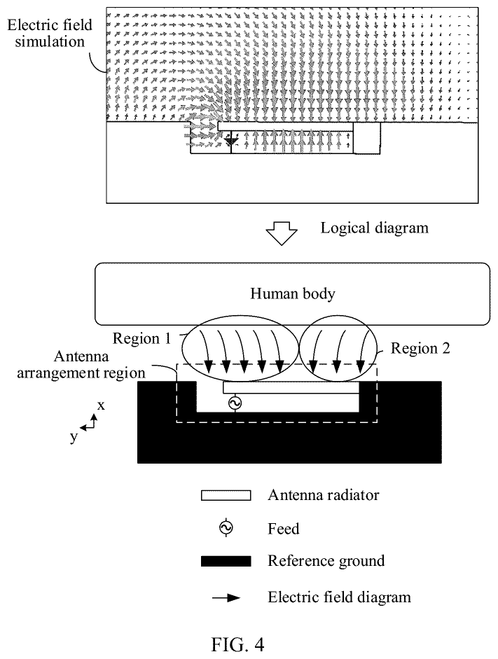

The loop antenna shown in FIG. 2 is used as an example. FIG. 4 shows a schematic diagram of electric field distribution when the loop antenna operates. For ease of description, a logical diagram corresponding to electric field simulation is also provided for illustration. In this example, the loop antenna may operate in a half wavelength mode. Correspondingly, the electric field distribution may be different in space near the feed and near the ground point. For example, in the example shown in FIG. 4, energy distribution is stronger in a region close to the feed (for example, a region 1) and weaker in a region close to the ground point (for example, a region 2). As a result, energy of most of radiated electromagnetic waves is concentrated in the region 1. From the perspective of the SAR, corresponding hotspots are concentrated, resulting in a higher SAR and a greater impact on the human body.

To resolve a problem of a high SAR of an existing antenna, embodiments of this application provide a terminal antenna. The antenna operates in a zero-order mode. First, the zero-order mode can generate relatively uniform electric field for radiation during operation, so that the energy distribution of the electromagnetic waves emitted by the antenna in various spatial regions around the antenna is more balanced. In this way, the hotspot concentration caused by high local energy is avoided, which makes the antenna have a lower SAR. Secondly, because uniform electric field distribution characteristics of the zero-order mode are not related to a size of the antenna, a length of the antenna may be set longer without changing the electric field distribution characteristics of the zero-order mode of the antenna, to further disperse the energy and reduce the SAR. In addition, the antenna may further provide better radiation performance, thereby providing better wireless communication quality.

The solution provided in embodiments of this application is described below in detail with reference to the accompanying drawings.

The antenna solution provided in embodiments of this application may be applied in an electronic device of a user, and is used to support a wireless communication function of the electronic device. For example, the electronic device may be a portable mobile device such as a mobile phone, a tablet computer, a personal digital assistant (personal digital assistant, PDA), an augmented reality (augmented reality, AR)/virtual reality (virtual reality, VR) device, or a media player. The electronic device may also be a wearable electronic device such as a smart watch. A specific form of the device is not specially limited in embodiments of this application.

An example in which an electronic device is a tablet computer is used. In other words, the antenna solution provided in embodiments of this application may be applied to a tablet computer, and is used to support a wireless communication function of the tablet computer. For example, the antenna may be configured to support Bluetooth communication, WLAN communication, and the like of the tablet computer. Correspondingly, an operating frequency band of the antenna may include one or more frequency bands among a Bluetooth frequency band (for example, 2.4 GHz), a 2.4G WIFI frequency band (for example, in a range of 2.4 GHz to 2.5 GHZ), and a 5G WIFI frequency band (for example, in a range of 5150 MHz to 5850 MHz).

In different implementations, the antenna may be arranged at different positions on the tablet computer based on different appearance IDs of the tablet computer.

An example in which a tablet computer has an appearance ID with an all-metal rear housing is used. The all-metal rear housing may mean that a rear housing of the tablet computer is made of a metal material, the rear housing may extend to a side surface of the tablet computer and wrap other components of the tablet computer, and is presented as a complete metal rear housing on a back surface and the side surface of the tablet computer.

FIG. 5 is a schematic composition diagram of an electronic device with an all-metal rear housing according to an embodiment of this application. As shown in FIG. 5, a rear housing 51, a circuit board 52, and a display screen 53 may be arranged in an electronic device (that is, a tablet computer) provided in embodiments of this application from bottom to top (that is, from a back surface to a front surface) along a z-axis.

The rear housing 51 may have an all-metal structure. A metal material forming the all-metal structure may include, for example, low-carbon steel, aviation aluminum, high-strength aluminum alloy, stainless steel, and/or titanium alloy. The rear housing 51 may be used as an appearance surface of the back based on a high strength characteristic of the all-metal structure, to provide basic support for the tablet computer. In some embodiments, an opening may be arranged on the rear housing 51, to implement a corresponding function in coordination with other components. For example, when a rear-facing camera is arranged on the tablet computer, an opening may be arranged on the rear housing 51 at a position corresponding to the rear-facing camera, so that a photographing component (for example, an image acquisition part of the camera) corresponding to the rear-facing camera can extend out of the opening, to implement a photographing function. In this example, the rear housing 51 may further extend from an xoy plane to a side surface (for example, an xoz plane and/or a yoz plane) through a corner, to implement an all-metal wrapped effect. Certainly, in some other embodiments, the rear housing 51 may alternatively be jointly made of a metal material and a non-metal material.

In this example, a window structure is arranged on a lateral side of the rear housing 51, to provide corresponding space for arranging some components of the tablet computer. For example, components such as an antenna may be arranged in the window structure.

It should be noted that, based on the all-metal structure of the rear housing 51, the rear housing 51 can provide a zero-potential reference of a large area. Therefore, the rear housing 51 can also be used as a reference ground for another electronic component (such as an antenna, a radio frequency component, or another electronic component).

Still with reference to FIG. 5, an internal component such as a circuit board 52 may also be arranged in the tablet computer in this application. The circuit board 52 may be prepared from a printed circuit board (Printed Circuit Board, PCB) and/or a flexible circuit board (Flexible Printed Circuit Board, FPC). In different implementations, there may be one or more circuit boards 52. The circuit board 52 may be used as a bearing structure for electronic components, and an interconnection between the electronic components is implemented by arranging signal transmission lines between the electronic components on the circuit board 52, to ensure operation of the electronic components. The circuit board 52 may also be electrically connected to other reference grounds and used as a reference ground for the antenna, and antenna ground may also be connected to the circuit board 52.

For example, a processor may be arranged on the circuit board 52. The processor may include one or more processing units. For example, the processor may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural network processing unit (neural-network processing unit, NPU), and the like. Different processing units may be independent devices or may be integrated in one or more processors. The processor can generate an operation control signal based on instruction operation code and a timing signal to complete control of fetching instructions and executing instructions. A memory may be further arranged in the processor and is configured to store instructions and data. In some embodiments, the memory in the processor may be a cache memory. The memory may store instructions or data that are used or used frequently by the processor. If the processor needs to use the instructions or the data, the processor may directly invoke the instructions or the data from the memory. This avoids repeated access, and reduces a waiting time of the processor, thereby improving system efficiency. In some embodiments, the processor may be a microprocessor unit (Microprocessor Unit, MPU) or a microcontroller unit (Microcontroller Unit, MCU).

A communication module such as a radio frequency module may further be arranged on the circuit board 52. The radio frequency module is connected to a baseband processor through a baseband line, and the radio frequency module may also be connected to an antenna, to implement a wireless communication function. For example, when transmitting a signal, the baseband processor sends a digital signal to the radio frequency module through the baseband line, and the radio frequency module converts and processes the digital signal, to obtain a corresponding analog signal. The radio frequency module transmits the analog signal to the antenna through the feed, so that the antenna converts the analog signal into electromagnetic waves to radiate outward. When receiving a signal, the antenna converts the electromagnetic waves into the analog signal carrying information and then transmits the analog signal to the radio frequency module through the feed. The radio frequency module performs radio frequency domain processing on the analog signal and then transmits the analog signal to the baseband processor. The baseband processor parses the signal and obtains the information carried in the received signal.

Still with reference to FIG. 5, a display screen 53 may further be arranged on the tablet computer in this application. The display screen 53 may be configured to provide a display function to a user. In some implementations, the display screen 53 may be mounted on a lateral side portion of the rear housing 51, to obtain an overall appearance of the tablet computer. For example, the display screen 53 includes appearance glass and a display component (or referred to as a display panel). The display panel may be a liquid crystal display (liquid crystal display, LCD), an organic light-emitting diode (organic light-emitting diode, OLED), an active-matrix organic light emitting diode (active-matrix organic light emitting diode, AMOLED), a flex light-emitting diode (flex light-emitting diode, FLED), a mini LED, a micro LED, a micro-OLED, a quantum dot light emitting diode (quantum dot light emitting diode, QLED), or the like. In some embodiments, the tablet computer may include one or more display screens 53.

In this application, an antenna may be further arranged between the circuit board 52 and the rear housing 51. In different implementations, a specific implementation of the antenna may be different. For example, the radiator of the antenna may be arranged on the circuit board 52, to implement a PCB antenna. In another example, the antenna may also be implemented by mounting on an antenna bracket in a form of FPC. In another example, the antenna may also be implemented by etching an antenna radiator on the antenna bracket through a laser direct structuring (Laser Direct Structuring, LDS) process. In addition, in some other embodiments, the antenna may alternatively be implemented by using processes such as metalframe diecasting for anodicoxidation (Metalframe Diecasting for Anodicoxidation, MDA) process and a stamping (Stamping) process. Alternatively, the antenna solution may be obtained with reference to the foregoing at least two implementations. A specific implementation form of the antenna is not limited in embodiments of this application.

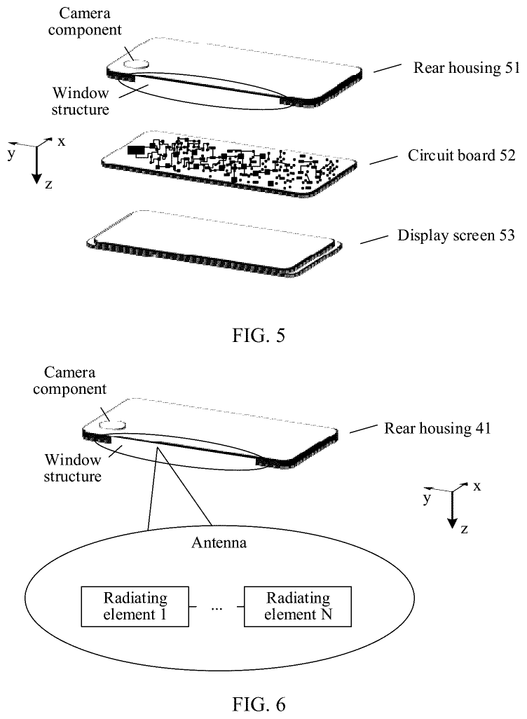

With reference to FIG. 6, in this application, a window structure may be arranged on a side surface of the rear housing 51, to provide radiation space on the side surface for an antenna in the window structure. In this way, when a radiator of the antenna is arranged in the window structure, the radiator can radiate to a side surface through the window structure while radiating through a front non-display region, to increase radiation performance of the antenna.

It should be understood that in some other embodiments, the antenna may further be arranged at a different position than that shown in FIG. 5 or FIG. 6. For example, if the rear housing 51 is made of a non-metal material, the antenna may be attached at any position inside the rear housing 51. A specific position at which the antenna is arranged does not affect composition and an operating mechanism of the antenna. In the following examples, an example in which the rear housing 51 is an all-metal rear housing and the antenna is arranged in a window structure is used.

As shown in FIG. 6, in the antenna solution provided in embodiments of this application, the antenna may include N radiating elements (for example, a radiating element 1 to a radiating element N), where N is an integer greater than or equal to 2. A quantity of the radiating elements may vary in different implementations. The N radiating elements are arranged in series end to end to obtain the antenna solution provided in embodiments of this application.

It should be noted that in different implementations, the N radiating elements forming the antenna may be completely the same, or may not be completely the same.

For example, for any radiating element, the radiating element may include a radiator. An electrical length of the radiator may not be greater than ¼ of the operating wavelength of the antenna. The electrical length of the radiator may be obtained by conversion based on electrical parameters such as a dielectric constant of a material used by the radiator. An example in which the operating frequency band of the antenna is 5G WIFI (that is, in a range of 5150 MHz to 5850 MHz) is used, a length of the radiator of the radiating element does not exceed 8 mm. For ease of description, in the following description, the electrical length of the radiator is briefly referred to as the length of the radiator.

It should be noted that in some implementations of this application, the length of the radiator of the radiating element may also be greater than ¼ of the operating wavelength of the antenna. In this way, a matching circuit may be arranged at the feed to adjust a resonance generated by the radiating element to a range of the operating frequency band.

An electrical connection point may be arranged at each end of the radiator of the radiating element. A feed may be arranged on the electrical connection point or grounded through an inductor.

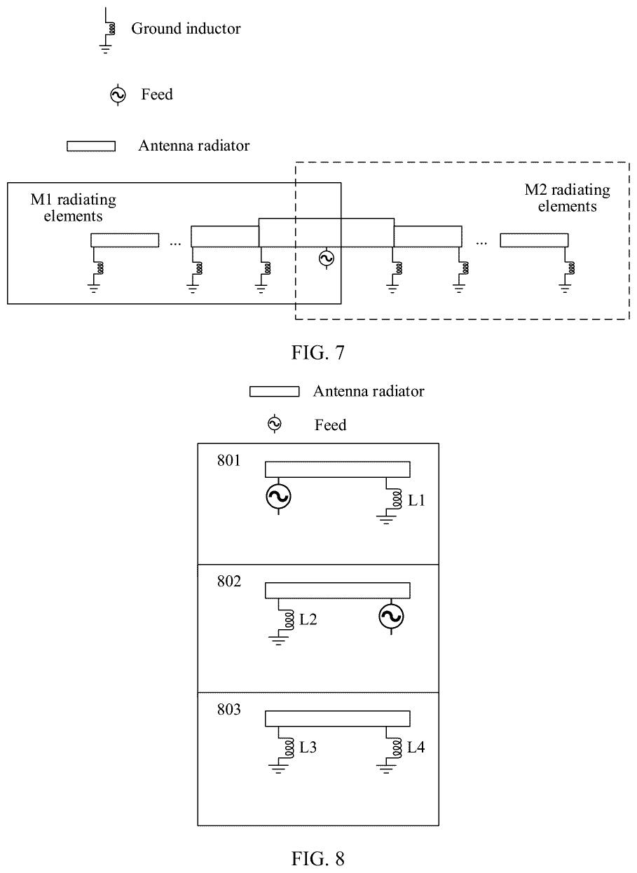

FIG. 7 shows a schematic structural diagram of a terminal antenna according to an embodiment of this application. In this example, the antenna may include a plurality of radiating elements. For example, a left side of the feed may include M1 radiating elements, and a right side of the feed may include M2 radiating elements. A sum of M1 and M2 is equal to N, where N is an integer greater than or equal to 2. When M1 is equal to M2, a corresponding feed is arranged at a middle position of an antenna radiator. This is a center-fed solution. When M1 is not equal to M2, it corresponds to an offset-fed solution. In some embodiments, as shown in FIG. 7, a width of the radiating element may gradually decrease with an increased distance between the radiating element and the feed.

It should be noted that in embodiments of this application, a connection between the feed and the antenna radiator may be a direct connection, or may be coupling through one or more port matching components. The port matching components may include a capacitor, an inductor, and/or a resistor. The one or more port matching components may be configured to adjust port impedance of the antenna, and/or to tune operating frequency of the antenna.

In some embodiments of this application, similar to the port matching component arranged at the feed, one or more ground matching components may also be arranged between any one or more ground inductors and the radiator as shown in FIG. 7, or between the ground inductor and the reference ground. The ground matching components may include a capacitor, an inductor, and/or a resistor. An example in which the ground matching component is a capacitor is used, one or more capacitors may be configured to adjust a frequency selection state when the antenna operates. For example, when a SAR sensor (SAR sensor) is arranged near the antenna, the one or more capacitors may be arranged to reduce or eliminate an impact of operation of the SAR sensor on operation of the antenna. In some other embodiments, the one or more capacitors may also be configured to tune the operating frequency band of the antenna.

The use and functions of the foregoing port matching components and ground matching components may be applied to implementation of any solution provided in embodiments of this application. For ease of description, the following uses an example in which the feed and the radiator are directly connected, and the radiator is directly connected to the reference ground at the ground inductor through the ground inductor.

From a perspective of structural composition of a single radiating element, the composition of the radiating element may be different in different embodiments.

In an example, referring to FIG. 8, in some embodiments, as shown in 801 in FIG. 8, a feed may be arranged at a left end of the radiator of the radiating element, and a right end of the radiator of the radiating element may be grounded through an inductor L1.

In some other embodiments, as shown in 802 in FIG. 8, the left end of the radiator of the radiating element may be grounded through an inductor L2, and a feed may be arranged at the right end of the radiator of the radiating element.

In some other embodiments, as shown in 803 in FIG. 8, the left end of the radiator of the radiating element may be grounded through an inductor L3, and the right end of the radiator of the radiating element may be grounded through an inductor L4.

L1, L2, L3 and L4 may have different inductance values, or at least two inductors with the same inductance value may be included. The inductance values of L1, L2, L3 and L4 may be flexibly selected based on the operating frequency band of the antenna. For example, an example in which the operating frequency band of the antenna is 5G WIFI (that is, in a range of 5150 MHz to 5850 MHz) is used, the inductance values of L1, L2, L3, and L4 may be in a range of 0.5 nH to 5 nH.

In this application, the antenna solution provided in embodiments of this application in FIG. 7 includes at least two or more radiating elements connected in series as shown in FIG. 8, and has only one feed.

It should be noted that, in FIG. 7, a feed and at least two ground points connected to a reference ground through an inductor are arranged in the antenna provided in embodiments of this application. In this way, boundary conditions of a plurality of inductors can make the antenna operate in the zero-order mode. In this case, the antenna may be equivalent to a material whose dielectric constant is close to zero. When the antenna operates, relatively uniform electric field distribution may be generated in surrounding space. In this example, when each radiating element operates, the electric field formed in space near each radiating element is dominated by the normal electric field. Radiation based on this uniformly distributed normal electric field can minimize the human body's absorption of the electromagnetic waves, to have a lower SAR while ensuring high radiation performance. In addition, the zero-order mode is not directly related to the length of the antenna, so that more radiating elements may be connected in series without changing the uniform electric field distribution characteristics of the antenna in the zero-order mode. A greater quantity of the radiating elements indicates the more dispersed energy. Therefore, increasing the quantity of the antenna elements may further reduce the SAR.

It may be understood that when the antenna radiates, an electric field/magnetic field absorption conversion situation between the antenna and the human body may be determined based on electromagnetic field boundary conditions. For example, the conversion situations between the electric field and the magnetic field are identified by using a normal component and a tangential component respectively. The normal component may be a component of the electric field lines directed from the antenna to the human body, or a component directed from the human body to the antenna. The tangential component is perpendicular to the normal component.

Conversion relationships of the electric field and magnetic field between the normal component and the tangential component are shown in Formula 1 to Formula 4:

$${E}_{n 2} = ( {ε}_{1} / {ε}_{2} ) {E}_{n 1} ; \qquad Formula ( 1 )$$

$${H}_{n 2} * ( {μ}_{1} / {μ}_{2} ) {H}_{n 1} ; \qquad Formula ( 2 )$$

$${E}_{t 2} = {E}_{t 1} ; \qquad Formula ( 3 )$$

$$and$$

$${H}_{t {2}^{=}} {H}_{t 1} . \qquad Formula ( 4 )$$

Formula (1) corresponds to a conversion relationship between the normal component Eₙ₁ of the electric field of the antenna and the normal component Eₙ₂ of the electric field generated in the human body. ε₁ is a dielectric constant of a dielectric material or air around the antenna, and ε₂ is a dielectric constant of the human body.

Formula (2) corresponds to a conversion relationship between the normal component Hₙ₁ of a magnetic field of the antenna and the normal component Hₙ₂ of a magnetic field generated in the human body. μ₁ is a magnetic permeability of the dielectric material or the air around the antenna, and μ₂ is a magnetic permeability of the human body.

Formula (3) corresponds to a conversion relationship between the normal component Eₜ₁ of the electric field of the antenna and the normal component Eₜ₂ of the electric field generated in the human body.

Formula (4) corresponds to a conversion relationship between the normal component Hₜ₁ of the magnetic field of the antenna and the normal component Hₜ₂ of the magnetic field generated in the human body.

The dielectric constant of the human body is much greater than the dielectric constant of the dielectric material (such as a plastic bracket) around commonly used antennas. For example, a relative dielectric constant of the human body is about 40, a dielectric constant of the plastic bracket is about 3, and a relative magnetic permeability of the two is 1. Therefore, based on Formula (1), when the electromagnetic waves between the antenna and the human body are mainly reflected as a normal electric field, the electric field generated in the human body may be much less than the antenna radiation. The smallest of absorption of the electromagnetic waves by the human body indicates the lowest SAR.

When the electromagnetic waves between the antenna and the human body are mainly reflected as the normal electric field, more balanced energy distribution (that is, uniform electric field) indicates a less concentrated local hotspot, so that the SAR is lower.

Based on the foregoing description, because the zero-order mode antenna solution provided in embodiments of this application can generate a nearly uniformly distributed normal electric field between the antenna and the human body, and the electric field distribution characteristics of the zero-order mode are not related to the length of the antenna, a plurality of radiating elements may be connected in series to further disperse energy, so that it has a lower SAR.

The following describes specific implementations of the antenna solution provided in embodiments of this application in detail by using examples.

For example, in some embodiments, the terminal antenna provided in embodiments of this application may include two radiating elements. The two radiating elements may be the same or may be different. Any radiating element may have the composition of any radiating element shown in FIG. 8.

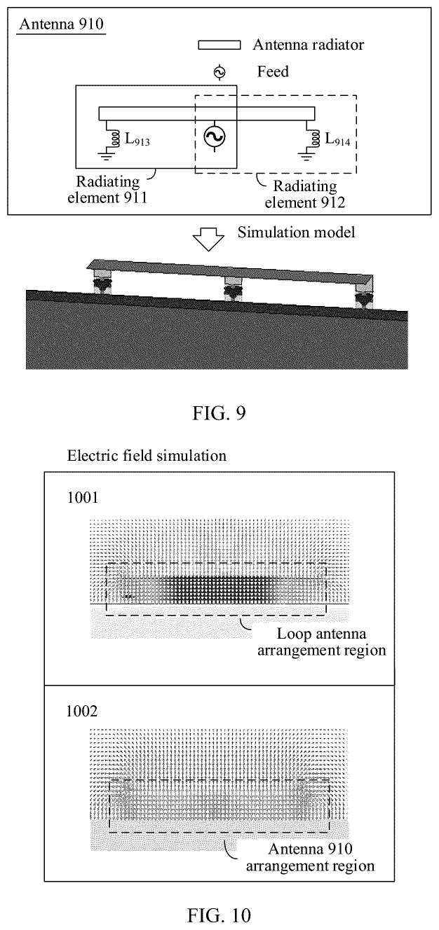

FIG. 9 is a schematic composition diagram of a terminal antenna according to an embodiment of this application. In addition, FIG. 9 also includes a simulation model diagram of the antenna solution.

As shown in FIG. 9, the antenna 910 may include two radiating elements, namely, a radiating element 911 and a radiating element 912. In this example, the radiating element 911 may have the composition of 802 shown in FIG. 8, and the radiating element 912 may have the composition of 801 shown in FIG. 8. Radiators of the radiating element 911 and the radiating element 912 may be connected to each other at an end where the feed is arranged. Correspondingly, a feed and ground inductors (such as L₉₁₃ and L₉₁₄) at two ends may be arranged on a radiator of the antenna 910 shown in FIG. 9. For arrangement of L₉₁₃ and L₉₁₄, reference may also be made to L1 to L4 in FIG. 8. Details are not described herein again.

In some embodiments, the antenna 910 shown in FIG. 9 may also be described as follows: The antenna 910 may include one radiator, and a length of the radiator does not exceed ½ of an operating wavelength. Ground inductors are respectively arranged at both ends of the radiator. Inductance values of the two ground inductors (such as L₉₁₃ and L₉₁₄) may be determined based on the operating frequency band. An example in which the operating frequency band covers a 5G WIFI frequency band is used, the inductance values of the two ground inductors L₉₁₃ and L₉₁₄ may be set in a range of 0.5 nH to 5 nH. In different embodiments, the inductance values of L₉₁₃ and L₉₁₄ may be the same or may be different. A feed may also be arranged on the antenna 910. A distance between the feed to any end does not exceed ¼ of the operating wavelength. For example, when a length of the radiating element 911 is the same as a length of the radiating element 912, the feed may be arranged at a middle position of the radiator of the antenna 910.

When the antenna 910 shown in FIG. 9 operates, a uniformly distributed electric field may be formed between the radiator of the antenna 910 and a reference ground and is used for radiation. The uniformly distributed electric field may be the normal electric field between the antenna and the human body. In this way, based on small absorption of the normal electric field by the human body and an effect of uneven distribution of uniformly distributed energy, the antenna 910 may obtain a lower SAR when operating.

For example, FIG. 10 shows an electric field simulation diagram of the antenna 910 shown in FIG. 9 during operation. A darker arrow color indicates greater electric field intensity. For comparison, FIG. 10 also shows an electric field simulation diagram when the loop antenna shown in FIG. 2 operates. As shown in FIG. 10, 1001 shows a schematic diagram of electric field distribution when the loop (loop) antenna operates. It can be seen that there is a strong electric field distributed at a middle position of a loop antenna arrangement region. Correspondingly, the electric field is weak at both ends of the loop antenna arrangement region. In other words, the electric field distribution when the loop antenna operates is not uniform. As shown in FIG. 10, 1002 shows an electric field simulation diagram when the antenna 910 operates in this application. It can be seen that when the antenna 910 operates, the electric field intensity in an antenna arrangement region (for example, an antenna 910 arrangement region shown in 1002) is uniformly distributed.

Based on the foregoing description, an electric field with uniform distribution characteristics may have a lower SAR.

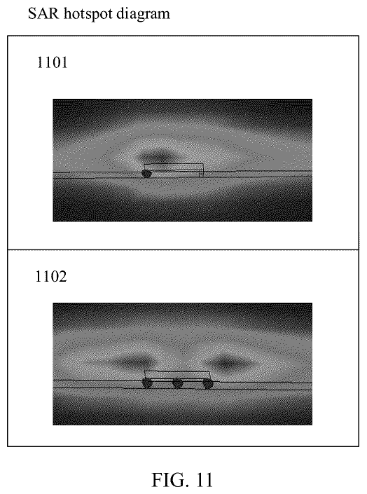

FIG. 11 shows a schematic diagram of an SAR test hotspot of the antenna 910 shown in FIG. 9. For comparison, FIG. 11 also shows a schematic diagram of an SAR test hotspot of the loop antenna shown in FIG. 2. A lighter color indicates stronger energy. 1101 in FIG. 11 shows a diagram of an SAR test hotspot of the loop antenna. It can be seen that when the loop antenna operates, there is one hotspot distributed near the antenna. In other words, most of the energy is concentrated in this hotspot region, and the SAR is high. 1102 in FIG. 11 shows a schematic diagram of an SAR test hotspot of the antenna 910. It can be seen that when the antenna 910 operates, there are two hotspots distributed near the antenna. In other words, the energy may be aggregated at two hotspots respectively. Therefore, energy intensity at each hotspot is smaller than the energy distribution at the hotspot of the loop antenna. Then, because the antenna 910 has more hotspots and the energy distribution is relatively more uniform, it can have a lower SAR than the loop antenna.

In an example, Table 1 shows simulation results of the loop antenna and the SAR of the antenna 910 for normalization by using omnidirectional radiation power. 0 mm body SAR is used as a simulation scenario, the operating frequency band is 5G WIFI, and a unit is W/kg.

TABLE 1

| Frequency point/GHz | Loop antenna-SAR-1 g | Antenna 910-SAR-1 g |
|---|---|---|
| 5.2 | 2.22 | 1.22 |
| 5.5 | 1.61 | 1.33 |
| 5.8 | 2.9 | 1.68 |

As shown in Table 1, at 5.2 GHZ, a 1 g SAR simulation result of the loop antenna is 2.22, and a 1 g SAR simulation result of the antenna 910 provided in this application is 1.22. At 5.5 GHz, the 1 g SAR simulation result of the loop antenna is 1.61, and the 1 g SAR simulation result of the antenna 910 provided in this application is 1.33. At 5.8 GHz, the 1 g SAR simulation result of the loop antenna is 2.9, and the 1 g SAR simulation result of the antenna 910 provided in this application is 1.68. It can be seen that in a full 5G WiFi frequency band, the SAR of the antenna 910 is significantly lower than that of the loop antenna.

It should be understood that in comparison of this example, to avoid inaccurate comparison results caused by inconsistent radiator lengths, in this application, the length of the radiator of the loop antenna and the length of the radiator of the antenna 910 are set to be the same, for example, 16 mm. The widths of the antennae are set to be the same, for example, 2 mm. Then, the loop antenna may cover the operating frequency band through a ½ wavelength mode. The antenna 910 may cover the operating frequency band by stimulating the uniform electric field to radiate in the zero-order mode. It should be noted that the electric field distribution characteristics of the zero-order mode of antenna stimulation provided in embodiments of this application may be determined by both a length of a radiator of any radiating element and a size of a ground inductor arranged on the radiating element. A greater quantity of the radiating elements included in the antenna indicates stronger radiation performance, but the uniform electric field distribution characteristics of stimulated zero-order mode does not change.

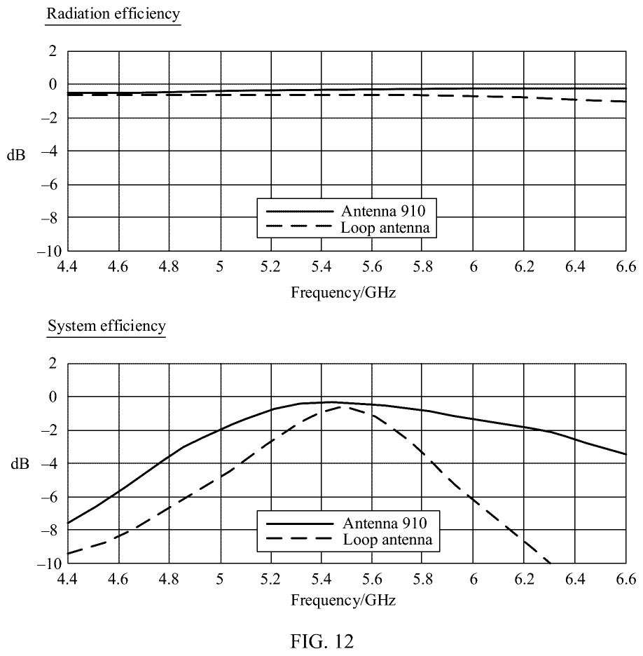

The antenna 910 provided in embodiments of this application can not only provide a lower SAR in the full frequency band, but also ensure better radiation performance. In an example, FIG. 12 shows efficiency simulation results of the antenna 910.

As shown in FIG. 12, from a perspective of radiation efficiency, the antenna 910 is higher than the loop antenna in the full frequency band. In other words, the antenna 910 can provide better radiation performance when ports in the full frequency band are fully matched. From a perspective of system efficiency, peak efficiency of the antenna 910 is about 0.2 dB higher than peak efficiency of the loop antenna, and a bandwidth is much greater than a bandwidth of the loop antenna. Efficiency in the full 5G WiFi frequency band is above-1.5 dB, and performance is even better, while the loop antenna is only above-4 dB. Therefore, the antenna 910 shown in FIG. 9 can not only provide lower SAR, but also provide better radiation performance.

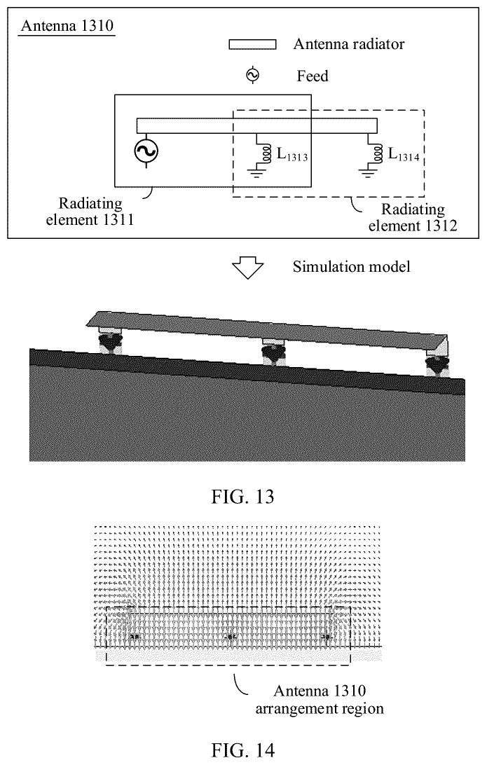

FIG. 13 is a schematic composition diagram of another terminal antenna according to an embodiment of this application. In addition, FIG. 13 also includes a simulation model diagram of this antenna solution.

As shown in FIG. 13, the antenna 1310 may include two radiating elements, namely, a radiating element 1311 and a radiating element 1312. In this example, the radiating element 1311 may have the composition of 801 shown in FIG. 8, and the radiating element 1312 may have the composition of 803 shown in FIG. 8. One end of the radiating element 1311 at which the ground inductor L₁₃₁₃ is arranged may be connected to any end of the radiating element 1312. At an end where the two radiating elements are connected to each other, the two ground inductors may be simplified into one ground inductor (such as inductor L₁₃₁₃). One end of the radiating element 1312 away from the radiating element 1311 may be grounded through an inductor L₁₃₁₄. For arrangement of the inductor L₁₃₁₃ and the inductor L₁₃₁₄, reference may also be made to L1 to L4 in FIG. 8. Details are not described herein again.

In some embodiments, the antenna 1310 shown in FIG. 13 may also be described as follows: The antenna 1310 may include one radiator, and a length of the radiator does not exceed ½ of an operating wavelength. A feed is arranged at one end of the radiator, and a ground inductor L₁₃₁₄ is arranged at the other end of the radiator. Another ground inductor L₁₃₁₃ may also be arranged on the radiator. An example in which an operating frequency band covers a 5G WIFI frequency band is used, inductance values of the two ground inductors may be set in a range of 0.5 nH to 5 nH. In different implementations, inductance values of the two ground inductors may be the same or may be different. A distance between the ground inductor L₁₃₁₃ arranged on the radiator and any end of the antenna 1310 does not exceed ¼ of the operating wavelength. For example, when a length of the radiating element 1311 is the same as the length of the radiating element 1312, the ground inductor L₁₃₁₃ arranged on the radiator other than the end may be located at a middle position of the radiator of the antenna 1310. Therefore, compared with the solution example shown in FIG. 9, the antenna 1310 may have characteristics of offset-fed arrangement.

When the antenna 1310 shown in FIG. 13 operates, a uniformly distributed electric field may be formed between the radiator of the antenna 1310 and the reference ground for radiation. The uniformly distributed electric field may be the normal electric field between the antenna and the human body. Different from the solution shown in FIG. 9, a uniform normal electric field may be distributed between the entire antenna 910 as a whole and the reference ground. In this example, the radiating element 1311 and the radiating element 1312 may respectively radiate based on the uniform normal electric field. Because the radiator of the radiating element 1311 and the radiator of the radiating element 1312 are at different distances from the feed, intensity of the normal electric fields generated by the radiating element 1311 and the radiating element 1312 may be slightly different. For example, the intensity of the normal electric field near the radiating element 1312 may be slightly smaller than the intensity of the normal electric field near the radiating element 1311.

In this way, based on small absorption of the normal electric field by the human body and an effect of uneven distribution of uniformly distributed energy, the antenna 1310 may obtain the lower SAR when operating.

For example, FIG. 14 shows an electric field simulation diagram of the antenna 1310 shown in FIG. 13 during operation. The darker arrow color indicates the greater electric field intensity. As shown in FIG. 14, when the antenna 1310 operates, the electric field intensity in an antenna arrangement region (for example, an antenna 1310 arrangement region shown in FIG. 14) is uniformly distributed. Based on the foregoing description, the electric field with the uniform distribution characteristics may have a lower SAR. Principles and conclusions are similar to those of the antenna 910.

In addition, in the foregoing simulation example of FIG. 13, similar to the simulation parameter arrangement corresponding to FIG. 9, to avoid inaccurate comparison results caused by inconsistent radiator sizes, in a simulation process in FIG. 13, the length of the radiator of the loop antenna and the length of the radiator of the antenna 1310 are set to be the same, for example, 16 mm. The widths of the antennae are set to be the same, for example, 2 mm. Then, the loop antenna may cover the operating frequency band through the ½ wavelength mode. The antenna 1310 may cover the operating frequency band by stimulating the uniform electric field to radiate in the zero-order mode. It should be noted that the electric field distribution characteristics of the zero-order mode of antenna stimulation provided in embodiments of this application may be determined by both a length of a radiator of any radiating element and a size of a ground inductor arranged on the radiating element. The greater quantity of the radiating elements included in the antenna indicates the stronger radiation performance, but the uniform electric field distribution characteristics of stimulated zero-order mode does not change.

It should be noted that in the solution of the antenna 1310 shown in FIG. 13, based on arrangement of the offset-fed structure, the electric field intensity generated by the two radiating elements is different. Then, from a perspective of overall electric field distribution, the energy is concentrated near the radiating element with larger electric field intensity. For example, the energy is concentrated near the radiating element 1311 including the feed. In this way, although the energy peak near the radiating element 1311 is weakened compared with the loop antenna, there is still a relatively obvious energy aggregation region.

In some other embodiments of this application, the size of the radiators of the radiating elements with different distances from the feed may be flexibly adjusted, so that the current on the radiator far away from the feed may also have current distribution density similar to that on the radiator close to the feed, to enable the radiating element far away from the feed to generate a uniform normal electric field of similar intensity as the radiating element close to the feed. As a result, the electric field intensity distribution near the antenna is further uniformly adjusted, to further reduce the SAR of the antenna.

An example in which the antenna includes two radiating elements is still used.

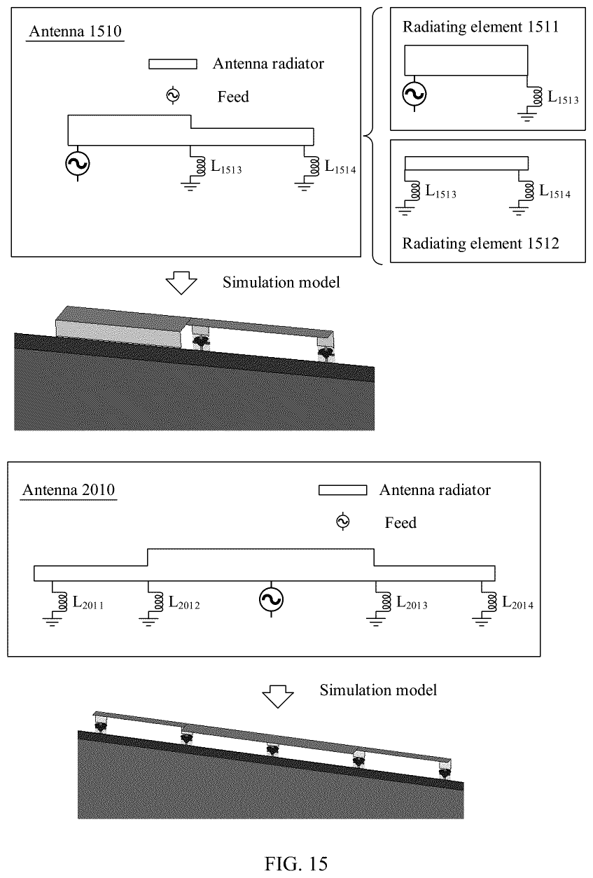

FIG. 15 is a schematic composition diagram of another terminal antenna according to an embodiment of this application.

In this example, an antenna 1510 may include two radiating elements, namely, a radiating element 1511 and a radiating element 1512. Similar to the composition of the antenna 1310 shown in FIG. 13, the radiating element 1511 in the antenna 1510 may have the composition of 801 as shown in FIG. 8, and the radiating element 1512 may have the composition of 803 as shown in FIG. 8. For example, in this example, a feed may be arranged at one end of the radiating element 1511, and a ground inductor L₁₅₁₃ may be arranged on the other end of the radiating element 1511. One end of the radiating element 1512 may be connected to one end of the radiating element 1511 at which the ground inductor L₁₅₁₃, and a ground inductor L₁₅₁₄ may be arranged on the other end of the radiating element 1512. The inductor L₁₅₁₃ may correspond to the inductor L₁₃₁₃ in the antenna 1310, and the inductor L₁₅₁₄ may correspond to the inductor L₁₃₁₄ in the antenna 1310. Different from the antenna 1310, the radiating element 1511 and the radiating element 1512 may have different sizes. For example, a width of the radiating element 1511 may be greater than a width of the radiating element 1512. In this way, when a current flows into the radiating element 1512, although current intensity is smaller than that on the radiating element 1511, due to reduction of a current transmission aperture, the current density on the radiating element 1512 does not change significantly. In this way, intensity of a uniform normal electric field generated by the current on the radiating element 1512 is close to intensity of a uniform normal electric field generated by the current on the radiating element 1511. Therefore, from a perspective of the antenna 1510 as a whole, the electric field distribution between the antenna radiator and the reference ground is more uniform than that of the antenna 1310, so that the SAR is lower.

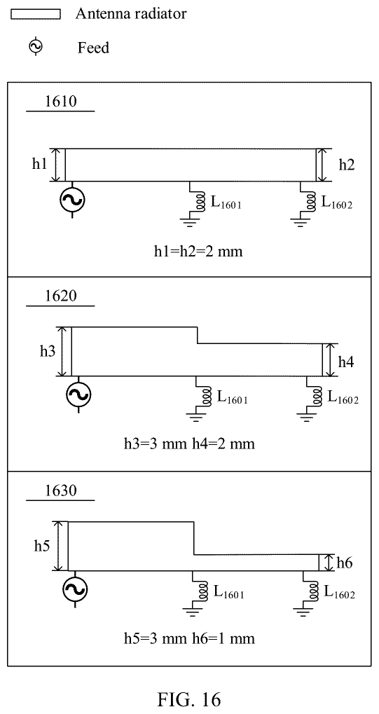

With reference to FIG. 16, specific implementations of several antennas 1510 are provided in embodiments of this application. For comparison, 1610 in FIG. 16 may correspond to the composition of the antenna 1310 shown in FIG. 13. An example in which the radiator width h1=h2=2 mm, a ground inductor arranged at the end of the antenna radiator is L₁₆₀₁, and a ground inductor arranged between the end of the radiator and the feed is L₁₆₀₂ is used. In different implementations, inductance values of L₁₆₀₁ and L₁₆₀₂ may be the same or may be different. An example in which the operating frequency band is 5G WiFi is used, the inductance values of L₁₆₀₁ and L₁₆₀₂ may be in a range of 0.5 nH to 5 nH.

1620 in FIG. 16 widens the width of the radiating element close to the feed based on 1610, for example, h3 may be set to 3 mm, and the width of the radiating element far away from the feed remains unchanged, for example, h4=2 mm. In this way, for the antenna with the composition shown in 1620, a radiating element close to the feed receives a larger current from the feed, and a current aperture is larger. A radiating element away from the feed receives a relatively small current, but a current aperture is smaller. Based on the above, the current density on the radiating element near the feed is not greatly different from that on the radiating element away from the feed. In this way, compared with the antenna composition shown in 1610, the electric field intensity near the radiating element close to the feed may be further reduced, to further reduce a value of the SAR. In addition, the radiation performance is better because the current distribution near the radiator is more uniform.

1630 in FIG. 16 reduces the width of the radiating element far away from the feed based on 1620. For example, h6 may be set to 1 mm, and the width of the radiating element close to the feed remains unchanged, for example, h5=3 mm. In this way, the current density on the radiating element close to the feed is closer to that of the radiating element far away from the feed, and a lower SAR and the better radiation performance may be obtained based on 1620.

In an example, Table 2 shows structural composition of 1610, 1620 and 1630 shown in FIG. 16 and simulation results of the 5G WiFi frequency band for normalization by using omnidirectional radiation power in a 0 mm 1 g SAR simulation scenario, where a unit is W/kg.

TABLE 2

| Frequency | Antenna 1610- | Antenna 1620- | Antenna 1630- |
|---|---|---|---|
| point/GHz | SAR | SAR | SAR |
| 5.2 | 2.36 | 1.98 | 2.03 |
| 5.5 | 2.64 | 2.31 | 1.62 |
| 5.8 | 3.36 | 3.01 | 2.32 |

It can be seen that based on the simulation results in Table 2, corresponding to the foregoing analysis, the antenna with the structure shown in 1630 has the best SAR, the antenna with the structure shown in 1620 has the second best SAR, and the antenna with the structure shown in 1610 has a relatively high SAR.

FIG. 9 to FIG. 16 provide descriptions by using an example in which the antenna includes two radiating elements. It can be seen that whether the feed is centered (the structure shown in FIG. 9) or the feed is offset (the structure shown in FIG. 13 or FIG. 15), a uniformly distributed normal electric field may be formed between the antenna radiator and the reference ground, thereby obtaining better radiation performance while obtaining lower SAR.

Because the uniformly distributed electric field characteristics of the zero-order mode are not related to the length of the antenna, a plurality of radiating elements may be connected in series to further disperse the energy, to further reduce the SAR. The following describes an antenna solution including more radiating elements with reference to the accompanying drawings.

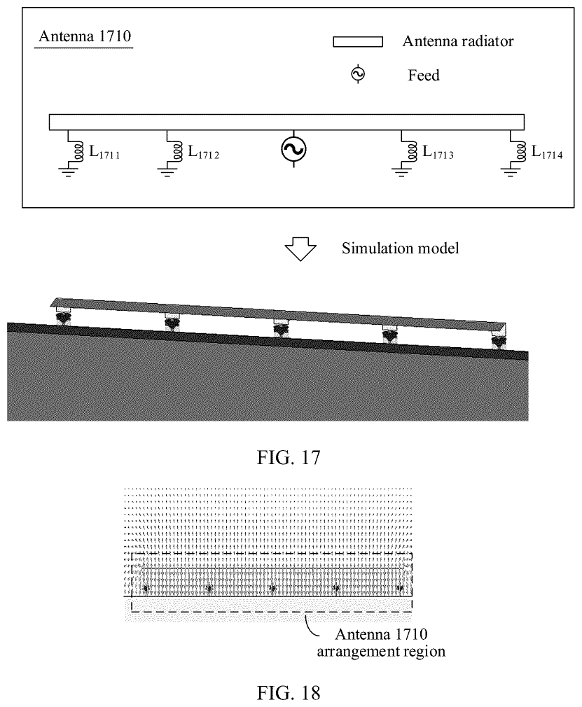

FIG. 17 is a schematic composition diagram of another terminal antenna according to an embodiment of this application.

In this example, an antenna 1710 may include four radiating elements. For selection and composition of the radiating elements, refer to the selection of two radiating elements in the foregoing example. For example, any one of the four radiating elements may use any one of examples shown in FIG. 8. In terms of the antenna as a whole, in the composition of the antenna 1710 in FIG. 17, an example in which the length of the radiator of the radiating element is the same is used. A feed may be arranged on the antenna 1710. The feed may be arranged at a middle position of the radiator. On two sides of the feed, two ground inductors may be uniformly arranged, for example, L₁₇₁₁, L₁₇₁₂, L₁₇₁₃ and L₁₇₁₄ from left to right. The feed may be arranged between Ling and L₁₇₁₂. For a clearer description, a simulation model of the antenna 1710 is also provided in FIG. 17. Similar to the foregoing description of the ground inductor, in different implementations, the inductance values of L₁₇₁₁, L₁₇₁₂, L₁₇₁₃ and L₁₇₁₄ may be the same or may be different. An example in which the operating frequency band is 5G WiFi is used, the inductance values of L₁₇₁₁, L₁₇₁₂, L₁₇₁₃ and L₁₇₁₄ may all be in a range of 0.5 nH to 5 nH.

With reference to the example of FIG. 9, the antenna 1710 shown in FIG. 17 may be obtained by successively arranging one radiating element on each sides of the antenna 910. The newly added radiating element may have structural composition as shown in 803 in FIG. 8. An example in which the length of the antenna 1710 in FIG. 17 is 32 mm is used, and the antenna 1710 is simulated to describe the operation of the antenna with reference to the simulation results.

FIG. 18 is an electric field distribution diagram when the antenna 1710 operates. It can be seen that when the antenna 1710 operates, although the length is doubled compared with the antenna 910, the antenna 1710 still maintains the zero-order mode, and the electric field distribution characteristics remain unchanged, and there is a uniform normal electric field distributed between the radiator and the reference ground (for example, an antenna 1710 arrangement region shown in FIG. 18). Therefore, the antenna 1710 may also have a lower SAR and better radiation performance. In addition, compared with the antenna 910, the size of the antenna 1710 is larger, so that the field intensity of the uniformly distributed normal electric field is lower. Therefore, the antenna 1710 may have a lower SAR than the antenna 910. By analogy, in different implementations of embodiments of this application, when the lengths of the radiating elements are the same, a greater quantity of the radiating elements forming the antenna indicates a lower SAR.

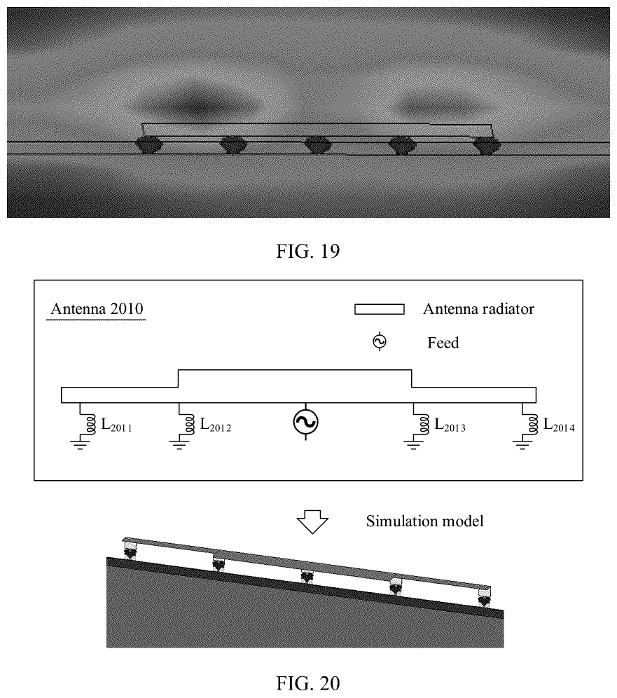

FIG. 19 is a schematic diagram of an SAR simulation hotspot of the antenna 1710. With reference to the hotspot distribution diagram of the antenna 910 shown in FIG. 11, the antenna 1710 may also have two hotspots distributed on two sides of the feed. In this example, the hotspot distribution region on two sides of the antenna 1710 is larger, so that the energy distribution is more dispersed and the SAR is relatively low. In an example, Table 3 shows simulation results of the SAR of the antenna 1710 for normalization by using omnidirectional radiation power, where a unit is W/kg.

TABLE 3

| Frequency point/GHz | Antenna 1710-SAR-1 g |
|---|---|
| 5.2 | 0.68 |
| 5.5 | 0.84 |
| 5.8 | 1.29 |

As shown in Table 3, a maximum SAR of the antenna 1710 is 1.29. Compared with a maximum SAR of the antenna 910 in Table 1 which is 1.68 and a maximum SAR of the antenna 1630 in Table 2 which is 2.32, the antenna 1710 including four radiating elements may provide a lower SAR.

With reference to the descriptions in FIG. 15 and FIG. 16, the current density on different radiating elements may be adjusted by adjusting the width of the radiating elements close to/away from the feed, to obtain better performance.

For example, with reference to the antenna 1710 shown in FIG. 17, based on the antenna 1710, the width of the radiating elements on two sides far away from the feed may be reduced, to increase the current density of the radiating elements away from the feed, thereby making the normal electric field distribution near the antenna more uniform.

In an example, FIG. 20 is a schematic composition diagram of a terminal antenna according to an embodiment of this application. As shown in FIG. 20, an antenna 2010 may include one radiator, and ground inductors may be respectively arranged on both ends of the radiator. An example in which four radiating elements have the same length is used. A total of four ground inductors may be arranged on the antenna 2010, namely, L₂₀₁₁, L₂₀₁₂, L₂₀₁₃ and L₂₀₁₄ from left to right. The feed may be arranged between L₂₀₁₃ and L₂₀₁₂. To provide a clearer description, a simulation model of the antenna 2010 is also provided in FIG. 20. Similar to the foregoing description of the ground inductor, in different implementations, inductance values of L₂₀₁₁, L₂₀₁₂, L₂₀₁₃ and L₂₀₁₄ may be the same or may be different. An example in which an operating frequency band of 5G WiFi is used, the inductance values of L₂₀₁₁, L₂₀₁₂, L₂₀₁₃ and L₂₀₁₄ may all be in a range of 0.5 nH to 5 nH. As shown in FIG. 20, in this example, a farther distance away from the feed indicates a narrower width of the radiating element. For example, the width of the radiating element between L₂₀₁₁ and L₂₀₁₂ may be smaller than the width of the radiating element between L₂₀₁₂ and the feed. In another example, the width of the radiating element between L₂₀₁₃ and L₂₀₁₄ may be smaller than the width of the radiating element between L₂₀₁₃ and the feed.

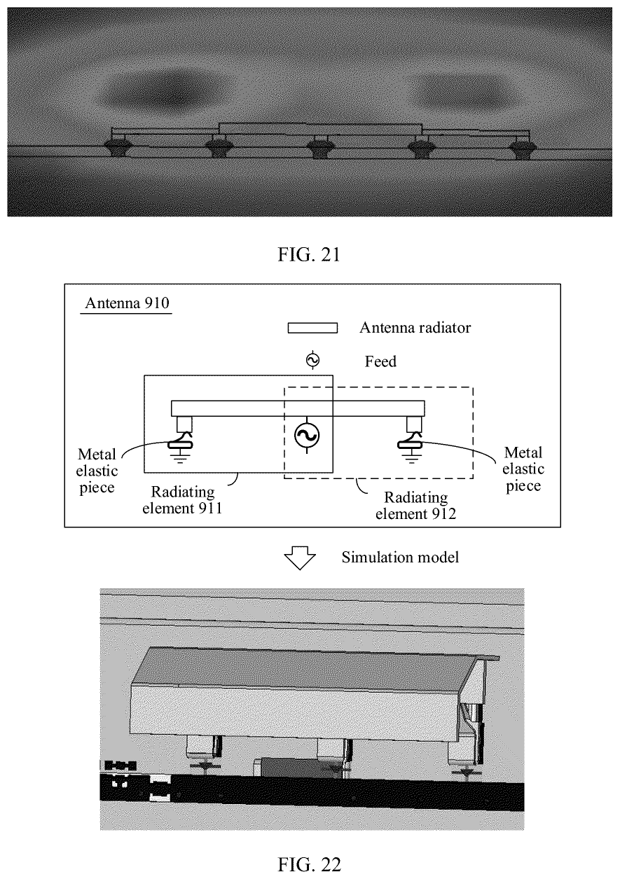

An example in which the width of narrower radiating elements at both ends of the antenna 2010 is 1 mm, and the width of the two radiating elements close to the feed is 2 mm is used. FIG. 21 is a schematic diagram of hotspot distribution of the antenna 2010. It can be seen that the antenna 2010 may also include two hotspots. Compared with the hotspot distribution of the antenna 1710 shown in FIG. 19, the distribution regions of the two hotspots are more dispersed, and the hotspots are located further away from the feed, so that the SAR is lower.

In an example, Table 4 shows simulation results of the SAR of the antenna 2010 for normalization by using omnidirectional radiation power, where a unit is W/kg.

TABLE 4

| Frequency point/GHz | Antenna 2010-SAR-1 g |
|---|---|
| 5.2 | 0.94 |
| 5.5 | 0.96 |
| 5.8 | 1.06 |

Compared with Table 3, Table 4 shows that a maximum SAR is further reduced from 1.29 for the antenna 1710 to 1.06 for the antenna 2010. It can be seen that the antenna 2010 may provide a lower SAR compared with the antenna 1710.

It should be understood that in the foregoing example, when the feed is arranged in the middle, the quantity of radiating elements on both sides may be the same. In some other embodiments of this application, when the feed is arranged in the middle, the quantity of the radiating elements on both sides may also be different. In addition, when two or more radiating elements are arranged on one side of the feed, the width of the radiating elements may be reduced as the distance from the feed increases, so that the current density is more uniformly distributed on the radiating element and better performance is obtained.

In addition, in the foregoing example, at least one end of the radiating element is grounded through the ground inductor. In some other embodiments of this application, the ground inductor may also be replaced by a distributed inductor or an equivalent inductance of another component.

For example, in some embodiments, the antenna 910 shown in FIG. 9 is used as an example. Refer to FIG. 22. The ground inductor at both ends of the antenna 910 may also implement an inductor ground function through electrical connection components. In this example, the electrical connection component may be a metal elastic piece. An equivalent inductance of the metal elastic piece may be the same as the ground inductor. An example in which the operating frequency band of the antenna is 5G WIFI (that is, in a range of 5150 MHz to 5850 MHz) is used, the equivalent inductance of the metal elastic piece may be in a range of 0.5 nH to 5 nH.

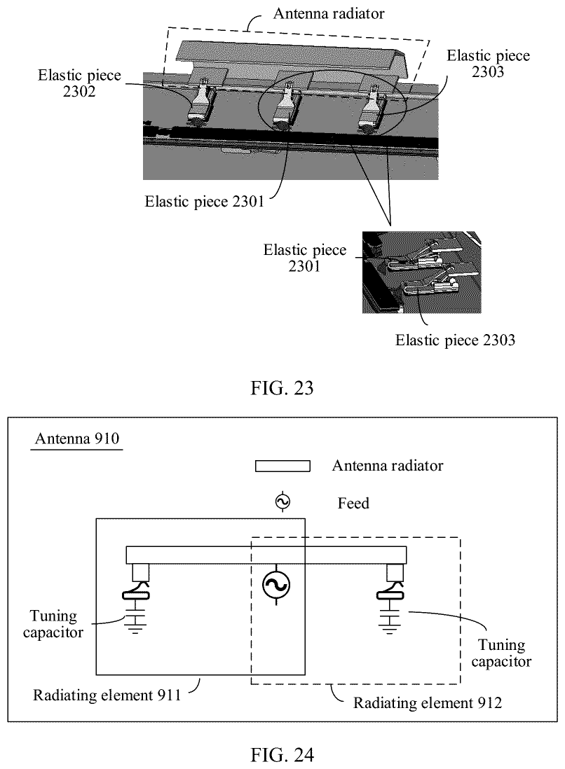

To describe the antenna solution shown in FIG. 22 in more detail, FIG. 23 shows a simulation model of the antenna solution shown in FIG. 22 from another perspective. As shown in FIG. 23, in this example, the antenna radiator of the antenna 910 may be of a 3D structure. For example, when the radiator of the antenna 910 is implemented through an FPC, the 3D structure of the antenna radiator shown in FIG. 23 may correspond to a copper-clad region on an FPC antenna, and the FPC antenna may be attached on an antenna bracket for support. As shown in FIG. 23, in this example, the function of the ground inductor may be implemented by a metal elastic piece (for example, an elastic piece 2302 and an elastic piece 2303) The elastic piece 2301 shown in FIG. 23 is a corresponding electrical connection component at the feed. The elastic piece 2301 may implement an electrical connection between the antenna and a radio frequency circuit on a main board or a small board at the feed, so that the electronic device can feed the antenna. In this example, exposed copper gold fingers may be arranged on the FPC antenna at corresponding positions of the elastic piece 2301, the elastic piece 2302, and the elastic piece 2303, to implement an electrical connection between the elastic piece 2301, the elastic piece 2302, and the elastic piece 2302 and the copper-clad region (that is, the antenna radiator) on the FPC antenna at the exposed copper gold fingers.

With reference to the foregoing description, in some embodiments of this application, a ground matching component may be arranged between the ground inductor (for example, a metal elastic piece shown in FIG. 22) and the reference ground. An example in which the ground matching component is a tuning capacitor is used. As shown in FIG. 24, the tuning capacitor may be arranged between metal elastic piece and the reference ground. In a specific implementation, the metal elastic piece may be welded on a PCB board, and the metal elastic piece may be coupled to the reference ground through a solder pad. In this example, the tuning capacitor may be arranged on a radio frequency microstrip between the solder pad and the reference ground for frequency selection and/or tuning of the operating frequency band.

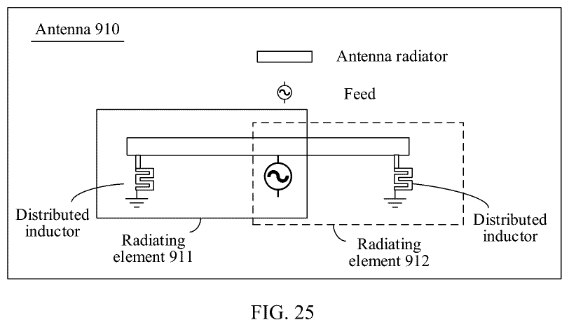

In some other embodiments, the antenna 910 shown in FIG. 9 is used as an example. Refer to FIG. 25. The ground inductors at both ends of the antenna 910 may also implement an inductor ground function through a distributed inductor. In this example, the distributed inductor may be a serpentine line radiator. An equivalent inductance of the serpentine line radiator may be the same as the ground inductor. For example, an example in which the operating frequency band of the antenna is 5G WIFI (that is, in a range of 5150 MHz to 5850 MHz) is used, the equivalent inductance of the serpentine line radiator may be in a range of 0.5 nH to 5 nH.

Although this application is described with reference to specific features and the embodiments thereof, apparently, various modifications and combinations may be made to this application without departing from the spirit and scope of this application. Correspondingly, the specification and the accompanying drawings are merely example descriptions of this application defined in the appended claims, and are considered as any one of or all modifications, variations, combinations or equivalents that cover the scope of this application. Certainly, a person skilled in the art can make various modifications and variations to this application without departing from the spirit and scope of this application. This application is intended to cover these modifications and variations of this application provided that they fall within the scope of protection defined by the following claims and their equivalent technologies.

1. A terminal antenna, wherein the terminal antenna is arranged in an electronic device, and the terminal antenna comprises:
a first radiator, wherein the first radiator comprising N radiating elements connected end to end, N being an integer greater than or equal to 2, and one end of any one of the radiating elements is grounded through a reactance element; and
the N radiating elements comprise a first radiating element, and a feed is arranged at one end of the first radiating element away from the reactance element.

2. The antenna according to claim 1, wherein that one end of any one of the radiating elements is grounded through the reactance element comprises that:
for any one of the radiating elements, the reactance element is arranged at one end of the radiating element away from the feed.

3. The antenna according to claim 1, wherein the N radiating elements further comprise a second radiating element, the second radiating element is arranged on one side of the first radiating element close to the feed, and the reactance element is arranged at a first end of the second radiating element; and
the second radiating element is connected to a third end of the first radiating element at a second end, the second end is different from the first end, and the third end is an end of the first radiating element at which the feed is arranged.

4. The antenna according to claim 1, wherein the N radiating elements further comprise a third radiating element, the third radiating element is arranged on one side of the first radiating element away from the feed, and the reactance element is arranged at a fourth end of the third radiating element; and
the third radiating element is connected to a sixth end of the first radiating element at a fifth end, the fifth end is different from the fourth end, and the sixth end is an end of the first radiating element away from the feed.

5. The antenna according to claim 1, wherein a length of any one of the radiating elements does not exceed ¼ wavelength of an operating frequency band of the terminal antenna.

6. The antenna according to claim 1, wherein among the N radiating elements, a farther distance away from the feed indicates a smaller width of the radiating element.

7. The antenna according to claim 1, wherein the reactance element comprises any one of the following: a lumped inductor, a distributed inductor, and an electrical connection component.

8. The antenna according to claim 7, wherein a tuning capacitor is further arranged between the reactance element and a reference ground.

9. The antenna according to claim 1, wherein an operating frequency band of the terminal antenna is in a range of 5150 MHz to 5850 MHZ, and an inductor of the reactance element is in a range of [0.5 nH, 5 nH].

10. The antenna according to claim 1, wherein a uniform normal electric field is distributed near a radiator of the terminal antenna when the terminal antenna operates.

11. An electronic device, wherein the electronic device comprises a terminal antenna; and when transmitting or receiving a signal, the electronic device transmits or receives the signal by using the terminal antenna; and the terminal antenna comprises:
a first radiator, wherein the first radiator comprising N radiating elements connected end to end, N being an integer greater than or equal to 2, and one end of any one of the radiating elements is grounded through a reactance element; and
the N radiating elements comprise a first radiating element, and a feed is arranged at one end of the first radiating element away from the reactance element.

12. The electronic device according to claim 11, wherein that one end of any one of the radiating elements is grounded through the reactance element comprises that:
for any one of the radiating elements, the reactance element is arranged at one end of the radiating element away from the feed.

13. The electronic device according to claim 11, wherein the N radiating elements further comprise a second radiating element, the second radiating element is arranged on one side of the first radiating element close to the feed, and the reactance element is arranged at a first end of the second radiating element; and
the second radiating element is connected to a third end of the first radiating element at a second end, the second end is different from the first end, and the third end is an end of the first radiating element at which the feed is arranged.

14. The electronic device according to claim 11, wherein the N radiating elements further comprise a third radiating element, the third radiating element is arranged on one side of the first radiating element away from the feed, and the reactance element is arranged at a fourth end of the third radiating element; and
the third radiating element is connected to a sixth end of the first radiating element at a fifth end, the fifth end is different from the fourth end, and the sixth end is an end of the first radiating element away from the feed.

15. The electronic device according to claim 11, wherein a length of any one of the radiating elements does not exceed ¼ wavelength of an operating frequency band of the terminal antenna.

16. The electronic device according to claim 11, wherein among the N radiating elements, a farther distance away from the feed indicates a smaller width of the radiating element.

17. The electronic device according to claim 11, wherein the reactance element comprises any one of the following: a lumped inductor, a distributed inductor, and an electrical connection component.

18. The electronic device according to claim 17, wherein a tuning capacitor is further arranged between the reactance element and a reference ground.

19. The electronic device according to claim 11, wherein the operating frequency band of the terminal antenna is in a range of 5150 MHz to 5850 MHz, and an inductor of the reactance element is in a range of [0.5 nH, 5 nH].

20. The electronic device according to claim 11, wherein a uniform normal electric field is distributed near a radiator of the terminal antenna when the terminal antenna operates.
